(19) United States
(12) Patent Application Publication
(10) Pub. No.: US 2023/0054432 A1
(43) Pub. Date: Feb. 23, 2023

(54) Multipurpose Wilderness Survival Tool

(71) Applicant: Christopher Michon, Hackensack, NJ (US)

(72) Inventor: Christopher Michon, Hackensack, NJ (US)

(21) Appl. No.: 17/701,852

(22) Filed: Mar. 23, 2022

Related U.S. Application Data
(60) Provisional application No. 63/233,815, filed on Aug. 17, 2021.

(51) Int. Cl. B25F 1/04; B25G 1/04; B25F 1/00; B25G 1/08; A01B 1/20; A01B 1/02

(52) U.S. Cl. CPC B25F 1/04; B25G 1/04; B25F 1/006; B25G 1/08; A01B 1/20; A01B 1/022; F23Q 1/06

(57) ABSTRACT

The present invention relates to a multipurpose tool for numerous uses while camping, hunting, backpacking, hiking, or other outdoor activities. The tool features a dual-edged shovel head which is attached to a handle using a pike. The pike allows a pivotable movement of the shovel head relative to the handle and a knob is configured to lock the shovel head in unfolded and folded positions. The tool features a built-in sleeve for a magnesium fire starter, a concealed compartment for holding a saw wire, and a small circular aluminum holder having holes for accommodating a plurality of detachable steel tools including a hammer, a pickaxe, a crowbar, and a chisel. A pole portion extends from the handle using a circular lever to increase a length of the tool and a button secures to a hole to secure and lock the pole portion in the extended state.

### CROSS-REFERENCE TO RELATED APPLICATION

The present application claims priority to, and the benefit of, U.S. Provisional Application No. 63/233,815, which was filed on Aug. 17, 2021 and is incorporated herein by reference in its entirety.

### FIELD OF THE INVENTION

The present invention relates generally to camping and hiking tools. More specifically, the present invention relates to a multipurpose tool for use while camping, backpacking, hunting, hiking, or other outdoor activities. The multipurpose tool features multiple hand tools and accessories integrated on or within the multipurpose tool via magnets. In a preferred embodiment, the tool features a double-bladed shovel head and an extendable pole, and is painted black or camouflage for concealment purposes and features a non-slip rubber handle. Accordingly, the present disclosure makes specific reference thereto. Nonetheless, it is to be appreciated that aspects of the present invention are also equally applicable to other like applications, devices, and methods of manufacture.

### BACKGROUND

By way of background, campers, backpackers, and hikers carry an assortment of tools along on their adventures. A variety of tools are typically required to help make repairs and conduct necessary tasks while on the trail. Separate tools are required for digging holes, chopping wood, creating a fire, self-defense, and much more. Carrying all necessary tools separately while in the wilderness is laborious and difficult. Oftentimes, people forget one or more wilderness survival tools, thereby making the trip more difficult. People desire a multi-tool that can provide all the necessary tools, and that can be used for performing a plurality of necessary tasks while camping, hunting, backpacking, hiking or during other outdoor activities.

Additionally, many wilderness survival tools are sharp and pointed and when stored in bags or other storage devices, may injure a person or cut through the bag. Therefore, people desire a multi-tool that they can safely carry, deploy and use to store and transport all necessary wilderness survival tools.

Currently, a user needs to select separate tools and purchase for use. Some campers and hikers are not experts and may select the wrong or inappropriate tools for their wilderness and outdoor adventures. People may also need a multi-tool that can be customized as per the requirements of a particular user, and that eliminates the need to purchase separate tools which can be both time-consuming and expensive.

Therefore, there exists a long-felt need in the art for a camping and hiking multi-tool device that keeps all of the necessary wilderness tools together and that prevents the same from being misplaced or lost. There is also a long-felt need in the art for a multi-tool that allows easy access to the individual tools comprising the same. Additionally, there is a long-felt need in the art for a camping multi-tool that eliminates the need to select and purchase separate wilderness tools, and that ensures that users are equipped with all necessary survival items while enjoying time outdoors. Further, there is a long-felt need in the art for a multi-tool that eliminates the need to carry multiple tools to and from a campsite, and that safely stores all the necessary wilderness tools in one convenient and compact location. Finally, there is a long-felt need in the art for a camping and hiking multi-tool that offers convenience, safety and utility for people during their wilderness activities.

The subject matter disclosed and claimed herein, in one embodiment thereof, comprises a multipurpose tool for use while camping, hiking and more. The tool is designed to be equipped with all the necessary survival items that may be required while enjoying time outdoors and that obviates the need to carry multiple tools to and from a campsite. In a preferred embodiment, the tool comprises: an elongated handle having a top end and an opposite bottom end; an extendable pole configured to extend from the bottom end of the handle using a circular lever; a concealed compartment disposed on said handle for storing a saw wire; a door for accessing said concealed compartment; a built-in sleeve for storing a magnesium fire starter; a dual-edged shovel head pivotally attached to said top end of the handle, wherein the shovel head is attached to the handle via a pike; a rotatable knob for locking pivotal movement of the shovel head; and a small circular aluminum holder for accommodating a plurality of detachable tools including a hammer, a pickaxe, a crowbar, a chisel, etc.

In this manner, the camping and hiking multi-tool device of the present invention accomplishes all of the foregoing objectives and provides users with a unique multi-tool for numerous uses while camping, hunting, backpacking, hiking, or otherwise outdoors. The tool features multiple hand tools and accessories integrated on and within the device via magnets for storing a pickaxe, a crowbar, a chisel, a hammer, and much more. The tool ensures that users are equipped with all the necessary survival items while enjoying time outdoors, thereby obviating the need to carry multiple tools to and from a campsite.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multipurpose tool for wilderness survival. The tool is designed as a comprehensive and useful multi-tool for wilderness survival and can be used while camping, hunting, backpacking, hiking, or otherwise outdoors for a variety of purposes. The tool comprises a handle having a top end and a bottom end; an extendable pole configured to extend from the bottom end of the handle; a concealed compartment disposed on said handle for holding a saw wire; a door for accessing said concealed compartment; a built-in sleeve for storing a magnesium fire starter; a dual-edged shovel head pivotally attached to said top end of the handle wherein the shovel head is attached to the handle using a pike; a rotatable knob for locking pivot movement of the shovel head; and a small circular aluminum holder for accommodating a plurality of detachable tools including a hammer, a pickaxe, a crowbar, and a chisel.

In yet another embodiment, a multi-tool for use in wilderness by a camper or hiker is disclosed. The multi-tool comprises a shovel head pivotally attached to a handle, wherein the shovel head has a dual layer of metal for support and sharp teeth or serrations along a portion of a periphery of the shovel head. The handle comprises a knob for locking the shovel head in a specific position. A pike attaches the shovel head to the handle and further provides support for digging. A concealed compartment around the middle of the handle is provided for storing saw wire and is accessible via a magnetic door, and a pair of magnets prevent sliding of a user's hand while using the multi-tool. A pole is also configured to be extendable from the handle, wherein a spring-biased button of the pole is secured to an opening of the handle to secure and lock the pole in extendable position.

In yet another embodiment, a method for enabling users to dig holes, chop wood, perform self-defense actions and several other tasks with a single tool is described. The method comprises the steps of providing the single tool, wherein the tool is a foldable shovel configured like a spear or a mace with a plurality of detachable tools including, without limitation, a hammer, pickaxe, crowbar and chisel, a concealed compartment for storing saw wire, and a built-in sleeve for a magnesium fire starter. The method may further comprise the steps of unfolding the shovel head using a knob and pike; starting a fire using the magnesium fire starter; and digging a hole using the shovel head.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a wilderness survival multi-tool of the present invention in accordance with the disclosed architecture;

FIG. 2 illustrates a front view of one potential embodiment of the wilderness survival multi-tool of the present invention in accordance with the disclosed architecture;

FIG. 3 illustrates a back view of one potential embodiment of the wilderness survival multi-tool of the present invention in accordance with the disclosed architecture;

FIG. 4 illustrates a side perspective view of one potential embodiment of the wilderness survival multi-tool of the present invention in accordance with the disclosed architecture; and

FIG. 5 illustrates a perspective view showing exemplary pickaxe detachable attachment that is held in one embodiment of the wilderness survival multi-tool of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a camping, backpacking, and hiking multi-tool device that keeps necessary wilderness tools together and prevents same from becoming misplaced or lost while in use or in transport. There is also a long-felt need in the art for a multi-tool that allows easy access of individual tools. Additionally, there is a long-felt need in the art for a camping multi-tool that eliminates the need to select and purchase separate wilderness tools. Moreover, there is a long-felt need in the art for a multi-tool that ensures users are equipped with all necessary survival items while enjoying time outdoors. Further, there is a long-felt need in the art for a multi-tool that eliminates the need to carry multiple tools to and from a campsite. Furthermore, there is a long-felt need in the art for a tool that safely stores all necessary wilderness tools. Finally, there is a long-felt need in the art for a camping and hiking multi-tool that offers convenience, safety, and utility for people during their wilderness adventures and outdoor activities.

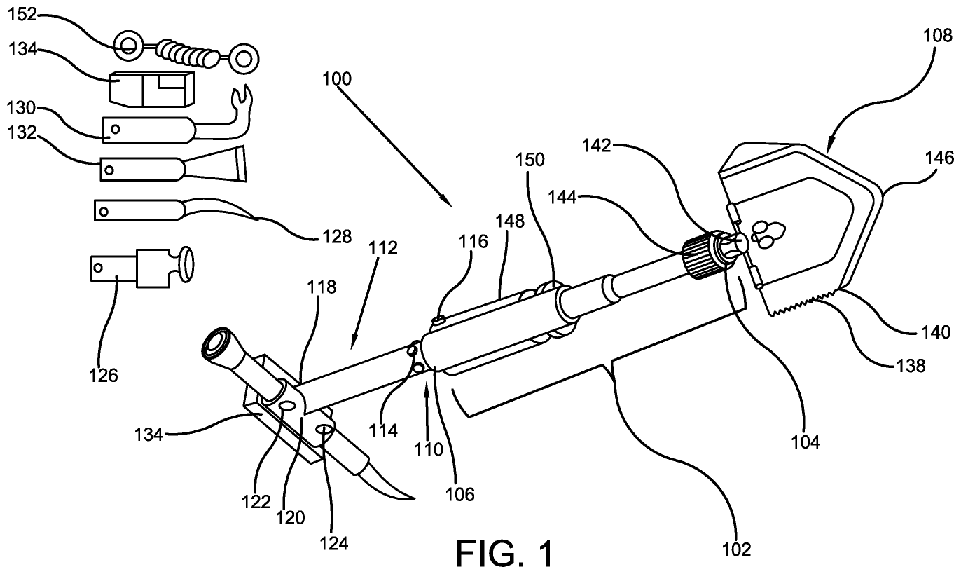

Referring initially to the drawings, FIG. 1 illustrates a perspective view of one potential embodiment of the wilderness survival and outdoor multi-tool of the present invention in accordance with the disclosed architecture. The wilderness survival multi-tool 100 of the present invention is a unique multi-tool used for a plurality of applications while camping, hunting, hiking, or other outdoor activities. The multi-tool 100 allows users such as campers, backpackers, and hikers to dig holes, chop wood, perform self-defense actions, and several other tasks without requiring multiple tools or single task-specific tools. More specifically, the multi-tool 100 is painted black for camouflage concealment and is configured as a foldable shovel like a spear or mace.

The multi-tool 100 includes a longitudinal steel handle 102 having a length from about 15 inches to about 30 inches and includes a top end 104 and a bottom end 106. The top end 104 is attached to foldable shovel head 108 and the bottom end 106 includes an extendable hidden or concealed pole opening 110. The extendable hidden or concealed (i.e., retractable) pole portion 112 is configured to extend from the handle 102 for use and can be hidden, concealed, or retracted inside a cavity of the steel handle 102 when not required. The pole portion 112 is expanded using a circular lever 114 that is rotated enabling the pole portion 112 to expand or extend out from the pole opening 110. When the pole portion 112 slides out from the handle 102, a small button 116 positioned on the pole portion 112 locks in a hole of the handle 102 enabling the pole portion 112 to securely lock in an extendable position. More specifically, the button 116 pops out of the hole thereby locking the pole portion 112.

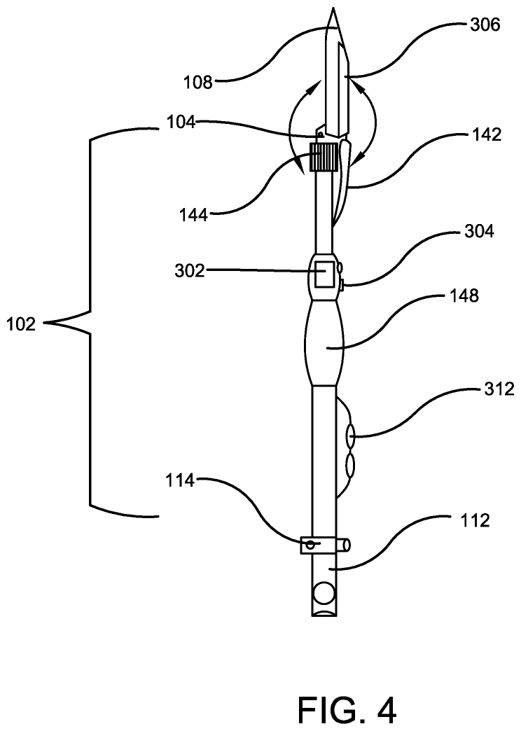

The pole portion 112 includes a bottom end 118 having a small circular aluminum holder 120 with two holes 122,124. The aluminum holder 120, along with holes 122,124, is used for accommodating a plurality of detachable stainless-steel tools. The detachable stainless-steel tools are used for a plurality of applications while camping, backpacking, hiking and more. Specifically, four detachable tools including a hammer 126, a pickaxe 128, a crowbar 130, and a chisel 132. Each of the tools is welded to steel pipes and each includes a button (shown in FIG. 4) that can be pushed down and slid in for it to pop out (i.e., spring biased) and lock in place when needed. The pole portion 112 includes a fire starter holder 134 welded to the aluminum holder 120. The fire starter holder 134 is used for storing a magnesium fire starter unit 136 that can be easily slid in or out for use.

The shovel head 108 of the multi-tool 100 is durable and dual edged for use in hard terrains and features sharp teeth or serrations 138 along an edge 140 of the razor-sharp perimeter. The shovel head 108 includes a pike 142 for supporting heavy weight during use. A twisting knob 144 is configured for twisting to unlock the shovel head 108 and for unfolding the shovel head 108. The twisting knob 144 can be twisted in an opposing direction to lock the shovel head 108. The twisting knob 144 allows easy handling and storage of the multipurpose shovel device 100 of the present invention.

The shovel head 108 includes a length from about 6 inches to about 12 inches from the pike 142 to the tip 146. Further, the shovel head 108 includes a width from about 4 inches to about 8 inches. The pole portion 112 includes a length from about 8 inches to about 16 inches including the small circular aluminum holder 120 and the fire starter holder 134. The device 100 includes a rubber grip 148 for enabling easy handling of the tool 100 during use and the grip 148 covers a portion of the handle 102.

A concealed component or repository 150 is disposed around a central area of the device 100 and is used for storing saw wire 152. The saw wire 152 can be selectively accessed by twisting a screw of the repository 150 as described later in the disclosure.

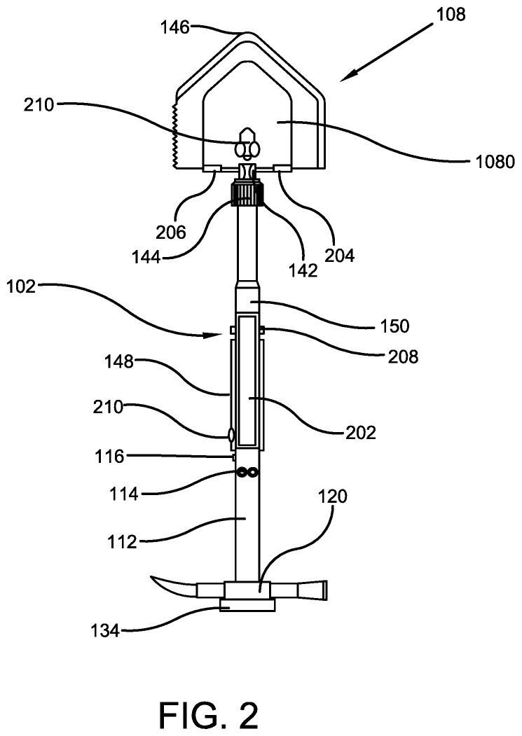

FIG. 2 illustrates a front view of the wilderness survival and outdoor multi-tool of the present invention in accordance with the disclosed architecture. As illustrated in the front view, the tool 100 includes a cavity 202 inside the handle 102 for accommodating the extendable pole portion 112 by rotating the circular lever 114. The spring biased button 116 positioned on the pole portion 112 is configured to be secured in the hole 212 for securing the pole portion 112 in an extendable position.

The concealed compartment 150 for storing saw wire 152 can be opened by a latch 208 positioned near the concealed compartment 150. It should be noted that concealed compartment 150 can be accessed from the back side of the tool 100. The shovel head 108, on its front surface, 1080 has an indentation or marking 210 of the double plating and additional metal layer fasteners. The shovel head 108 includes a pair of treads 204,206 enabling a user to put a foot on the respective treads 204,206 while using the shovel head 108. The small circular aluminum holder 120 and the fire starter holder 134 are integrated to the pole portion 112 and can be dimensioned and designed as per preference of a user.

Height of the multi-tool 100 ranging from the tip 146 of the shovel head 108 to the fire started holder 134 is 41.5 inches, in the preferred embodiment, when the pole portion 112 is an extended position. For storage, the shovel head 108 can be folded using the pike 142 and the pole portion 112 can be stored inside the cavity 202 of the handle 102.

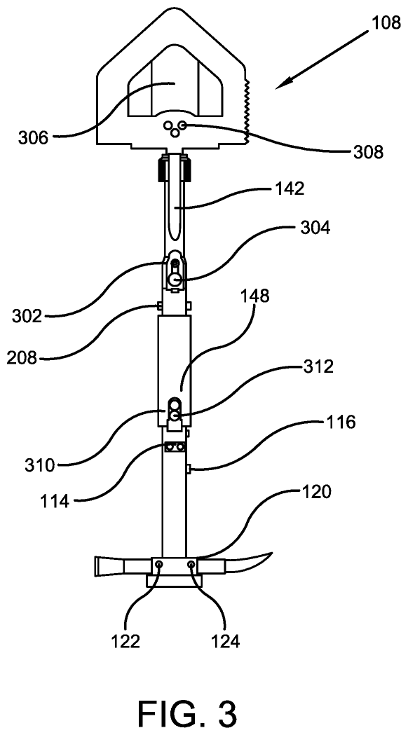

FIG. 3 illustrates a back view of the multi-tool 100 of the present invention in accordance with the disclosed architecture. As illustrated, the shovel head 108 is dual layered using an additional layer 306 of metal for providing additional support. The additional layer 306 is supported by fasteners 308. The additional layer 306 may cover 75% of the total area of the shovel head 108. The pike 142 provides additional support to the shovel head 108 when the tool 100 is used for digging a surface. The length of the pike 142 can be in the range from about 8 inches to about 10 inches.

A door 302 is positioned on the handle for accessing the concealed compartment storing the saw wire. The door 302 can be opened by the magnetic latch 208 that uses the magnet 304. The rubber grip 148 is positioned below the door 302 thereby enabling a user to easily grip the handle 102 while accessing the saw wire stored in the concealed compartment.

The multi-tool 100 includes a firm piece 310 at the bottom end of the handle 102 and holds two magnets 312 that prevent the hands of a user using the tool 100 from sliding and further preventing the button 116 from blocking the firm piece 310. The circular level 114 is used for extending and retracting the hidden or concealed (i.e., retractable) pole portion 112.

The holes 122,124 are designed to accommodate the detachable stainless-steel tools as described in FIG. 1 wherein the tools can be removably attached into the aluminum holder 120.

FIG. 4 illustrates a side perspective view of the wilderness survival and outdoor multi-tool 100 of the present invention in accordance with the disclosed architecture. As shown, the multi-tool 100 includes a one-piece handle 102 with the shovel head 108 pivotable using the pike 142 at the top end 104. The door 302 for the concealed compartment is accessible using the first magnet 304 for accessing saw wire 152. The rubber grip 148 is positioned below the door 302 and the concealed compartment and the two magnets 312 prevent the hands of users from sliding.

The latch 114 allows the pole portion 112 to extend and retract inside the handle 102 enabling easy storage of the tool 100. It should be understood that the tool 100 is sturdy, durable, sleek, and weatherproof.

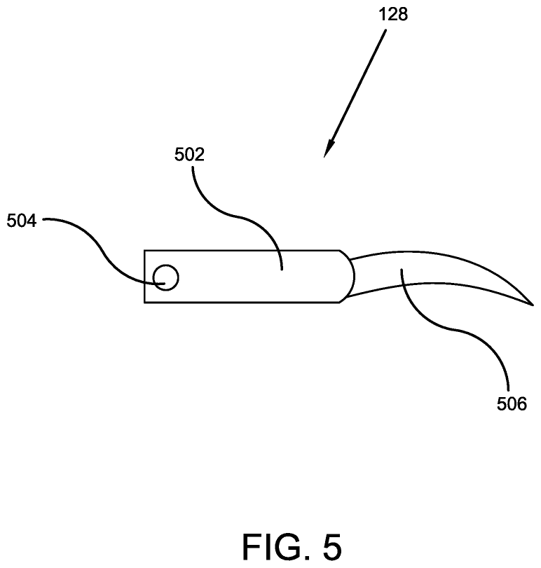

FIG. 5 illustrates a perspective view showing exemplary pickaxe detachable attachment that is held in the multi-tool 100 of the present invention in accordance with the disclosed architecture. Each of the detachable tools, hammer, pickaxe, crowbar, and chisel, illustrated in FIG. 1 has similar structure for securing to the holes of the small circular aluminum holder. As an example, the pickaxe 128 includes a welded steel pipe 502 that includes a button 504 that can be pushed down and slid in the holes for the button 504 to pop out (i.e., spring biased) and lock in place when needed. The working arm 506 can be of any suitable metal or alloy.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “wilderness survival multi-tool”, “multi-tool”, “tool”, “device”, and “multipurpose shovel device” are interchangeable and refer to the wilderness survival multi-tool 100 of the present invention.

Notwithstanding the foregoing, the wilderness survival multi-tool 100 of the present invention can be of any suitable size and configuration as is known in the art without affecting the overall concept of the invention, provided that it accomplishes the above-stated objectives. One of ordinary skill in the art will appreciate that the wilderness survival multi-tool 100 as shown in the FIGS. are for illustrative purposes only, and that many other sizes and shapes of the wilderness survival multi-tool 100 are well within the scope of the present disclosure. Although the dimensions of the wilderness survival multi-tool 100 are important design parameters for user convenience, the wilderness survival multi-tool 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multi-tool for housing and mounting a plurality of outdoor tools, the multi-tool comprising:
a longitudinal handle having a length from about 15 inches to about 30 inches and having a top end and a bottom end;
wherein said top end includes a release knob for pivoting a shovel head from a deployed position to a folded position;
wherein said bottom end of said handle includes a pole opening for extending and retracting a pole portion therefrom and said pole portion configured for an extension from said bottom end of said handle for use and for retraction inside a cavity of said handle for storage;
wherein said pole portion includes a lever for rotating and enabling said extension of said pole portion from said bottom end of said handle;
wherein said extension includes a sliding of said pole portion out from said pole opening;
a biased button on said pole portion for locking into a hole in said handle when said pole portion is in said extension position;
wherein said pole portion includes a bottom end including a holder with a pair of holes, and further wherein said holder and said pair of holes accommodates selectively one of said multitude of tools; and
further wherein said multitude of tools is selected from a group consisting of a hammer, a pickaxe, a crowbar and a chisel.

2. The multi-tool of claim 1, wherein each one of said multitude of tools includes a spring biased button for locking into said bottom end of said pole portion.

3. The multi-tool of claim 2, wherein said pole portion includes a fire starter holder attached to said holder.

4. The multi-tool of claim 3, wherein said fire starter holder includes a magnesium fire starter unit.

5. The multi-tool of claim 4, wherein said shovel head includes dual edges and at least one edge of said dual edges includes a serrated edge.

6. The multi-tool of claim 5, wherein said shovel head includes a pike for supporting a heavy weight during use of said multi-tool.

7. The multi-tool of claim 6, wherein said shovel includes a length from about 6 inches to about 12 inches from said pike to a tip of said shovel head.

8. The multi-tool of claim 7, wherein said shove head includes a width from about 4 inches to about 8 inches.

9. The multi-tool of claim 8, wherein said pole portion includes a length from about 8 inches to about 16 inches.

10. The multi-tool of claim 9, wherein said handle includes a grip covering a portion of said handle.

11. The multi-tool of claim 10, wherein said handle includes a concealed repository for storing a saw wire.

12. A multi-tool for housing and mounting a plurality of outdoor tools, the multi-tool comprising:
a longitudinal handle having a top end and a bottom end;
wherein said top end includes a release knob for pivoting a shovel head from a deployed position to a folded position;
wherein said bottom end of said handle includes a pole opening for extending and retracting a pole portion therefrom and said pole portion configured for an extension from said bottom end of said handle for use and for retraction inside a cavity of said handle for storage;
wherein said pole portion includes a lever for rotating and enabling said extension of said pole portion from said bottom end of said handle;
wherein said extension includes a sliding of said pole portion out from said pole opening;
a biased button on said pole portion for locking into a hole in said handle when said pole portion is in said extension position;
wherein said pole portion includes a bottom end including a holder with a pair of holes, and further wherein said holder and said pair of holes accommodates selectively one of said multitude of tools; and
further wherein said shovel head includes dual edges and at least one edge of said dual edges includes a serrated edge.

13. The multi-tool of claim 12, wherein said multitude of tools is selected from a group consisting of a hammer, a pickaxe, a crowbar, and a chisel.

14. The multi-tool of claim 13, wherein each one of said multitude of tools includes a spring biased button for locking into said bottom end of said pole portion.

15. The multi-tool of claim 12, wherein said pole portion includes a fire starter holder attached to said holder.

16. The multi-tool of claim 15, wherein said fire starter holder includes a magnesium fire starter unit.

17. The multi-tool of claim 12, wherein said shovel head includes a pike for supporting a heavy weight during use of said multi-tool.

18. The multi-tool of claim 17, wherein said shovel includes a length from about 6 inches to about 12 inches from said pike to a tip of said shovel head, and a width from about 4 inches to about 8 inches.

19. A multi-tool for housing and mounting a plurality of outdoor tools, the multi-tool comprising:
a longitudinal handle having a top end and a bottom end;
wherein said top end includes a release knob for pivoting a shovel head from a deployed position to a folded position;
wherein said bottom end of said handle includes a pole opening for extending and retracting a pole portion therefrom, and said pole portion configured for an extension from said bottom end of said handle for use and for retraction inside a cavity of said handle for storage;
wherein said pole portion includes a lever for rotating and enabling said extension of said pole portion from said bottom end of said handle;
wherein said extension includes a sliding of said pole portion out from said pole opening;
a biased button on said pole portion for locking into a hole in said handle when said pole portion is in said extension position;
wherein said pole portion includes a bottom end including a holder with a pair of holes, and further wherein said holder and said pair of holes accommodates selectively one of said multitude of tools;
wherein said shovel head includes dual edges and at least one edge of said dual edges includes a serrated edge; and
further wherein said handle includes a concealed repository for storing a saw wire.

20. The multi-tool of claim 19, wherein said multitude of tools is selected from a group consisting of a hammer, a pickaxe, a crowbar and a chisel.
